(19) United States
(12) Patent Application Publication
(10) Pub. No.: US 2005/0190286 A1
(43) Pub. Date: Sep. 1, 2005

(54) Integrated array sensor for real time measurements of biological samples

(76) Inventors: Gregory Kaduchak, Los Alamos, NM (US); Dipen N. Sinha, Los Alamos, NM (US); John C. Martin, Los Alamos, NM (US)

Correspondence Address: UNIVERSITY OF CALIFORNIA;LOS ALAMOS NATIONAL LABORATORY, P.O. BOX 1663, MS A187, LOS ALAMOS, NM, 87545, US

(21) Appl. No.: 10/789,487

(22) Filed: Feb. 26, 2004

(51) Int. Cl. H04N 5/222

(52) U.S. Cl. 348/370

(57) ABSTRACT

An integrated array of light sensitive pixels has a surface configured to receive the small particles within a distance effective for the particles to affect the pixel readout amplitude and where the pixels have an area on the order of the area of the small particles to be directly imaged. A collimated light source is provided for illuminating the integrated array. A video display receives an output from the pixels to provide an image of the small particles directly contacting the surface of the array.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates generally to the imaging of particles on a semiconductor array sensor, and, more particularly, to imaging small particles, such as biological materials, directly on the surface of a semiconductor array sensor.

### BACKGROUND OF THE INVENTION

Integrated electronic circuit arrays are used in a variety of ways in the handling and analysis of small particles, particularly biological particles (“bioparticles”). Suitable arrays are generally based on CCD (charge-coupled device) or CMOS (complementary metal oxide semiconductor) technology. Typical arrays have a two-dimensional array of pixel areas, where a pixel is a small sensitive area device that accumulates charge from either photons impacting the surface of the pixel or from chemical reactions occurring on the surface of the pixel. Current technology can provide pixel sizes on the order of 2 μm. Data is generally acquired from individual pixels to form a digital representation of the charge accumulated in individual pixels.

In many conventional applications with existing imaging instruments, biological reactions occur that introduce fluorophores in an oligonucleotide chain when selected conditions are present. When the fluorophore is illuminated by radiation of an appropriate wavelength, the fluorophore fluoresces and the emitted light is detected by the sensor array to indicate the presence or absence of the selected conditions. A lens system is used to direct the emitted light onto the sensor array. Other light transmissions that are characteristic of bioparticles may also be imaged through a lens system onto the sensor array. See, e.g., U.S. Patent Application Publications U.S. Ser. No. 2002/0018199 (Feb. 14, 2002) and U.S. Ser. No. 2002/0030811 (Mar. 14, 2002), PCT Application No. PCT/US01/5156 (WO 02/093144 published Nov. 21, 2002), and Golden et al., A comparison of imaging methods for use in an array biosensor, 17 Biosensors and bioelectronics, pp. 719-725 (2002).

In another approach, U.S. Patent Application Publication 2002/0165675, published Nov. 7, 2002, teaches CCD and CMOS arrays with large pixels (100 μm×100 μm) having surface treatments that are capable of forming conjugates with probes, which, in turn, are capable of binding to selected molecular structures. The output of the individual pixels is determined by the presence or absence of a probe/molecule reaction on the pixel. In this instance, the pixels are not sensitive to incident light and are sensitive only to charges or currents from the surface reactions.

Thus, the present devices for visualizing small particles, such as bioparticles, require a surface for holding the particles remote from the sensor array and a lens or other guide system for directing emitted or transmitted light onto the sensor array. These components result in a system that is relatively large and expensive. In accordance with the present invention, particles are applied in direct proximity to the surface of the sensor array without the use of any optics, whereby the sensor surface becomes a small, inexpensive imaging array device that can determine a number of particle properties, such as particle count, particle size, induced fluorescence, broad-band differential absorption, antibody reactions, and the like.

Various advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

In accordance with the purposes of the present invention, as embodied and broadly described herein, the present invention includes an apparatus for direct imaging of small particles. An integrated array of light sensitive pixels has a surface configured to receive the small particles within a distance effective for the particles to affect the pixel readout amplitude and where the pixels have an area on the order of the area of the small particles to be directly imaged. A collimated light source is provided for illuminating the integrated array. A video display receives an output from the pixels to provide an image of the small particles directly contacting the surface of the array.

Another characterization of the present invention includes an apparatus for directly imaging small particles having an integrated array of light sensitive pixels with a surface configured to directly receive the small particles within a distance effective for a selected characteristic of the particles to be directly detected by the light sensitive pixels and where the pixels have an area on the order of the area of the small particles to be directly imaged. An output from the light sensitive pixels is directed to a video display to provide an image of the selected characteristic of the small particles directly contacting the surface of the array.

### BRIEF DESCRIPTION OF THE DRAWINGS

The accompanying drawings, which are incorporated in and form a part of the specification, illustrate embodiments of the present invention and, together with the description, serve to explain the principles of the invention. In the drawings:

FIG. 1 pictorially illustrates one embodiment of the present invention.

FIGS. 2A and 2B pictorially illustrate a biological particle placed directly on the light sensitive surface of a pixel sensor array and the associated output display from the array.

FIG. 3 is a side view of a sensor array configured to provide an image of small particles placed on the array.

FIGS. 4A and 4B illustrate one application of the present invention to record images of the growth of a biological culture placed directly on the surface of a sensor array.

### DETAILED DESCRIPTION

The array sensor of the present invention has recognized that extremely small particles can be directly imaged on a semiconductor pixel sensor array. Suitable pixel sensor arrays are CCD arrays and CMOS arrays with pixel sizes generally less than about 5 microns square. As used herein, the term “extremely small particles” means particles having a size on the order of magnitude as a pixel size. Further, the term “directly imaged” means that a selected characteristic of the small particles is detected by the array pixels without any optical devices between the array surface and the small particles.

Various light sources and configurations can be used for providing collimated illumination of samples located on the detection array. Sources include: light emitting diodes, laser diodes, other lasers, small discharge lamps (for UV and other wavelengths), and incandescent lamps. Possible configurations include 1) different wavelengths of light for illumination and/or excitation, 2) different intensities of the illumination light, 3) pulsed illumination, 4) multiple illumination wavelengths which might be pulsed on and off in an ordered sequence, and 5) polarized illumination.

Detecting images of micro-particles with direct imaging on the detector array is accomplished with some or all of the following optical processes: absorption (i.e. shadowing), scattering of light (diffraction and refraction), and emission of light from excitation by the illumination wavelength (i.e. fluorescence, phosphorescence, or other types of delayed emission). In absorption measurements there is usually one or more optimum wavelengths to use for the best absorption signal; thus, one should use an appropriate wavelength for detection of absorption signals. Scattering signals will change with wavelength for a given particle size, but it is not as sensitive as the absorption. Therefore scattering measurements are often usually at a convenient wavelength. However if the scattered light shows up as a background problem one might want to select an illumination wavelength that minimizes the scatter signal. Fluorescence, phosphorescence and other forms of delayed emission are similar to absorption in that they are optimally excited at certain wavelengths. Finally, using polarized illumination along with a crossed polarizer (thin film type) between the sample and the detection array can provide significant improvements in discrimination for detecting desired objects.

The sensor array herein takes into account that diffraction effects can limit the ability of such extremely small particles to form an image on the pixel sensors. Thus, the surface of the sensor array must be configured so that the extremely small particles directly contact the active surface of the sensor and are not elevated by surface coatings and the like more than a distance where the pixel amplitude is no longer affected by the presence of the particles. This distance will vary depending upon the type of illumination and the optical process that is employed (e.g. absorption, scattering of light, or delayed light emission) and can be readily determined by routine experimentation.

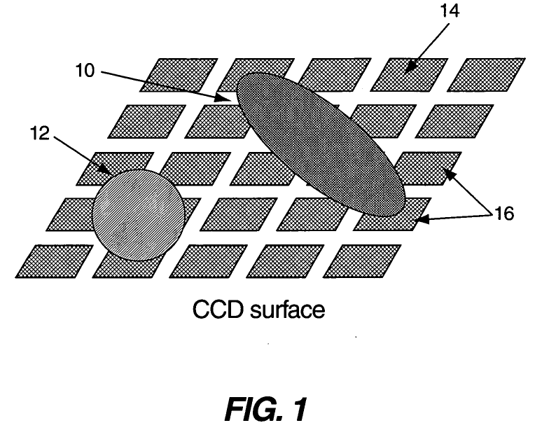

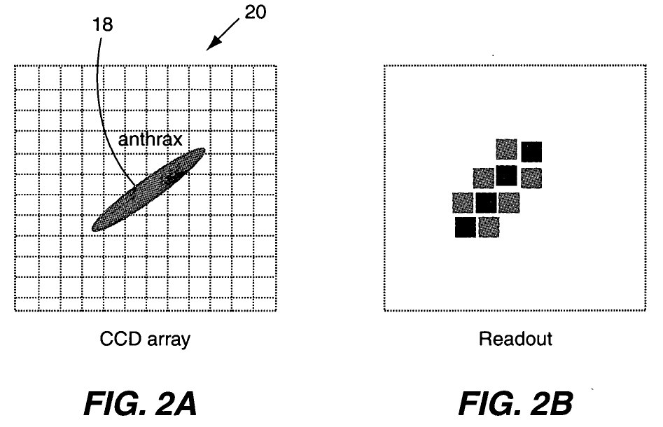

Thus, the direct-contact array sensor according to the present invention is a sensor that has a rapid response, is extremely small, requires low electrical power, is inexpensive, and may be disposable. As shown pictorially in FIG. 1, extremely small particles 10, 12, which may be biological particles, are placed in direct contact with the active light detecting surface 14 of the sensor pixels 16. FIGS. 2A and 2B pictorially illustrate a biological particle 18, such as E. coli, Bacillus Subtilis, Bacillus Anthracis, or the like, having a length of 4-5 microns, placed in direct contact with a pixel array 20 with pixel sizes of about 2 microns with a corresponding pixel output map, or readout 22 from the sensor array. Such extremely small particles (bacteria, cells, pollen, and the like) in such close proximity to the surface of the sensor array form shadows on the sensor array surface when illuminated from above by collimated light in the ultra-violet, visible, and infra-red wavelength range. The size and shape of the resulting video image is determined by the number of shadowed pixels of the sensor array.

Current CCD technology provides pixel sizes of about 2 microns square. CMOS technology provides pixel sizes of about a single micron square. Thus, the image of any extremely small particle of a size a single micron or greater can be obtained and the size measured to within a single micron. Additionally, using an appropriate sensor array, fluorescence occurring in or on a biological particle can be detected and located to a resolution of about a single micron. Clearly, the resolution will improve as sensor arrays advance to much smaller pixel sizes.

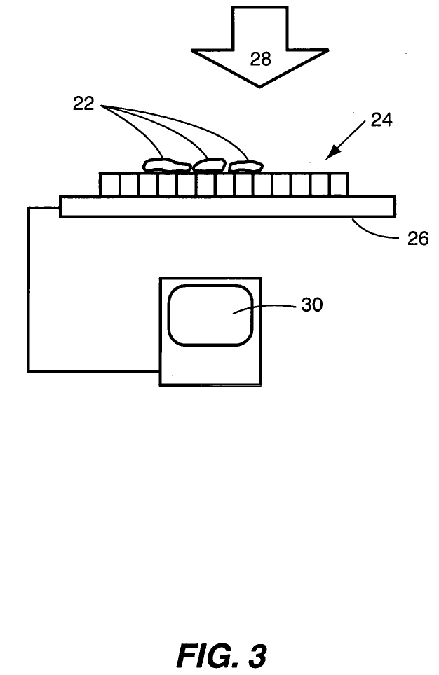

FIG. 3 is a side view of a typical array system according to the present invention. Extremely small particles 22 are placed in direct contact with the surface of sensor array 24, which is supported by array carrier 26. The surface is illuminated by a collimated light 28 of a selected wavelength and the illuminated surface of array 24 produces a charge in the illuminated pixels and generates an output signal to a video viewing system 30 to visualize the extremely small particles on the surface. Video viewing system 30 may be a dedicated computer monitor of any conventional type or may be a general purpose or hand-held computer that is programmed to provide a video image of the output from the sensor array.

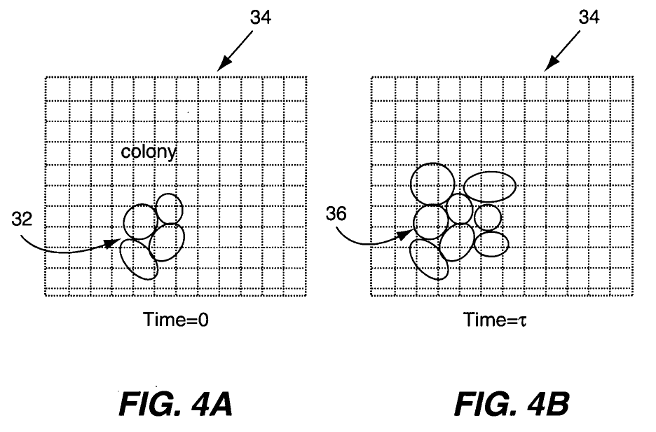

FIGS. 4A and 4B illustrate one exemplary application of the above invention. A biological specimen 32 is placed in direct contact with the sensing surface of sensor array 34 in the presence of a culture medium and biological specimen 32 is directly imaged, as seen in FIG. 4A. The growth kinetic may be directly observed on a cell-by-cell basis by monitoring the individual pixel intensities of the growing culture 36, as seen in FIG. 4B.

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. An apparatus for directly imaging small particles consisting essentially of:
an integrated array of light sensitive pixels having a surface configured to receive the small particles within a distance effective for the particles to affect the pixel readout amplitude and where the pixels have an area on the order of the area of the small particles to be directly imaged;
a light source for illuminating the integrated array; and
means for displaying an output from the pixels to provide an image of the small particles directly contacting the surface of the array.

2. The apparatus of claim 1, wherein the integrated array of light sensitive pixels is selected from the group consisting of CCD arrays and CMOS arrays.

3. The apparatus of claim 2, where the pixel area is less than about 5 micron square.

4. A method for directly imaging small particles comprising:
forming an integrated array of light sensitive pixels having a surface configured to receive the small particles within a distance above a light sensitive surface of the pixels effective to detect selected characteristics of the small particles;
placing the small particles directly on the surface of the pixels;
outputting an image signal from individual ones of the light sensitive pixels; and
displaying the image signal to provide a visualization of the small particles.

5. The method of claim 4, further including the step of selecting an integrated array having pixel sizes less than the size of the small particles.

6. The method of claim 4, further including the step of illuminating with a collimated light source the integrated array of light sensitive pixels having the small particles on the surface of the pixels.

7. An apparatus for directly imaging small particles comprising:
an integrated array of light sensitive pixels having a surface configured to directly receive the small particles within a distance effective for a selected characteristic of the particles to be directly detected by the light sensitive pixels and where the light sensitive pixels have an area on the order of the area of the small particles to be directly imaged;
video means for displaying an output from the light sensitive pixels to provide an image of the selected characteristic of the small particles directly contacting the surface of the array.

8. The apparatus of claim 7, wherein the integrated array of light sensitive pixels is selected from the group consisting of CCD arrays and CMOS arrays.

9. The apparatus of claim 8, where the selected characteristic is selected from the group consisting of: absorption, light scattering, and light emission.
